(19) United States
(12) Patent Application Publication
(10) Pub. No.: US 2016/0020655 A1
(43) Pub. Date: Jan. 21, 2016

(54) Shaft-Driven Electrical Device

(71) Applicant: Craig Cummings, Kirkland, WA (US)

(72) Inventor: Craig Cummings, Kirkland, WA (US)

(21) Appl. No.: 14/335,835

(22) Filed: Jul. 18, 2014

(51) Int. Cl. H02K 1/27; F02C 7/32; F02C 6/00; F02N 11/04; F02C 7/26

(52) U.S. Cl. CPC H02K 1/2793; F02N 11/04; F02C 7/26; F02C 6/00; F02C 7/32; F05D 2260/85; F05D 2220/323; F05D 2300/121; F05D 2300/14

(57) ABSTRACT

A shaft-driven electrical device is disclosed. The shaft-driven electrical device may be for a piston-aircraft engine or a turbine aircraft engine. The shaft-driven electrical device for a piston-aircraft engine may include an engine, a plurality of coils, a flywheel, an output shaft and a spinner. The shaft-driven electrical device for a turbine aircraft engine may include an engine, a plurality of coils, a propeller spinner backplate, an output shaft and a spinner. The shaft-driven electrical device may serve as an electric generator, an electric motor, or a starter.

### FIELD

This disclosure relates to an electrical device. More specifically, this disclosure relates to a shaft-driven electrical device.

### BACKGROUND

General aviation aircraft often utilize one or more gear-driven alternators or one or more belt-driven alternators powered by an engine to provide electrical power for one or more instruments and for a charging system. While effective, these alternators are often not very efficient mechanically. Starters are generally gear-driven and are also not efficient mechanically. Conventional starters also sometimes place excess torque on crankshafts or propellers when initially activated.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, a shaft-driven electrical device, which may be utilized as an electric generator, an electric motor, or both an electric generator and an electric motor or a starter. Magnets may be mounted to a flywheel or a propeller spinner back plate and may be powered directly by an output shaft of an aircraft's piston engine or turbine engine. One having skill in the art will recognize that other means may be used to hold magnets near windings, such as a cup-shaped device allowing the magnets to encircle the windings.

A plurality of windings may be mounted to an engine casing, with electricity generated via induction. A plurality of brushes may not be required, which may increase mechanically efficiency during electric generation, although brushes may be used in some embodiments. In one embodiment, a stator may be mounted around an output shaft and a plurality of magnets may be mounted to the propeller shaft.

In one embodiment, a shaft-driven electrical device may generate electricity, by rotating the magnets near the coils. In another embodiment, electricity may be fed to the coils, which may repel the magnets and cause a rotational moment, providing an electric motor. Such a motor may augment power from the aircraft's engine, or may be used as a starter for the engine.

Many of the attendant features may be more readily appreciated as they become better understood by reference to the following detailed description considered in connection with the attached drawings.

### BRIEF DESCRIPTION OF THE DRAWINGS

The present invention will be described by way of exemplary embodiments, but not limitations, illustrated in the accompanying drawing in which like references denote similar elements, and in which:

FIG. 1 is a side view of a shaft-driven electrical device, according to one embodiment.

FIG. 2 is a view of a flywheel with coupled magnets, according to one embodiment.

FIG. 3 is a side view of a shaft-driven electrical device, according to another embodiment.

FIG. 4 is an illustration of a shaft-driven electrical device, according to one embodiment.

### DETAILED DESCRIPTION

Various aspects of the illustrative embodiments will be described utilizing terms commonly employed by those skilled in the art to convey the substance of their work to others skilled in the art. However, it will be apparent to those skilled in the art that Shaft-Driven Electrical Device may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

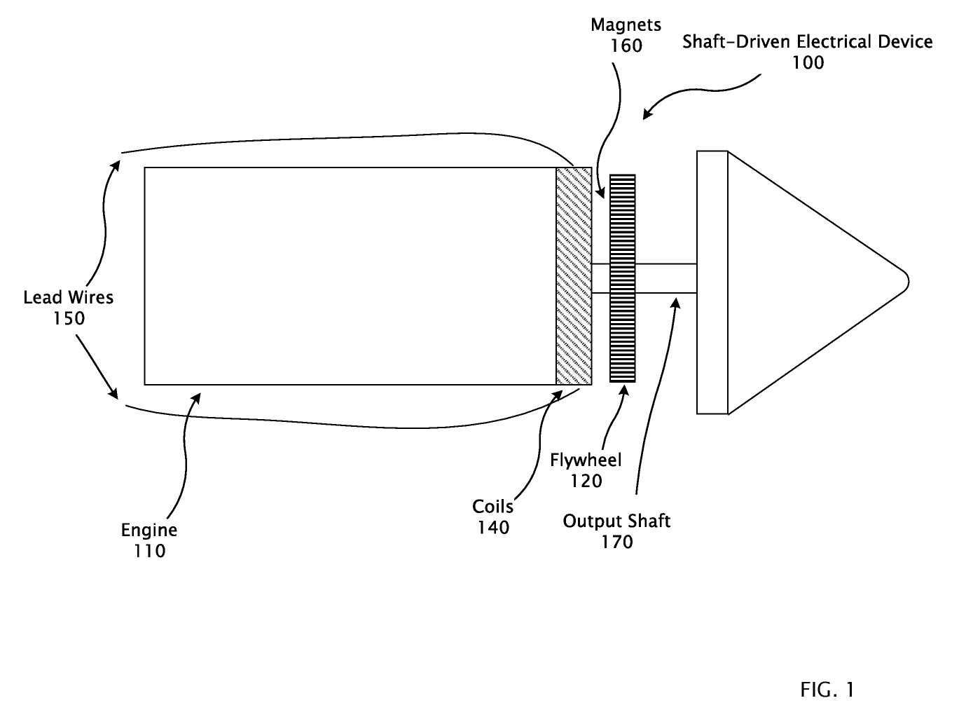

FIG. 1 is a side view of Shaft-Driven Electrical Device 100, according to one embodiment. This embodiment may be implemented with an aircraft piston-engine, for example. Shaft-Driven Electrical Device 100 may act as a generator or an electric motor, depending on configuration. In this embodiment, Shaft-Driven Electrical Device 100 may be mounted to piston-driven aircraft Engine 110. Output Shaft 170 may be driven by Engine 110 in a conventional manner. Magnets 160 may be coupled to Flywheel 120, which may be rotated by Output Shaft 170. Magnets 160 may be permanent magnets, or may be electromagnets. Many types of magnets may be used, and may be selected for cost, strength, weight, or other properties relevant to the application. Physical considerations, such as the distance between Magnets 160 and Coils 140 may be considered in selecting appropriate magnet types. Mounting Magnets 160 to Flywheel 120 may exploit an advantage that low weight may not be as much of a concern as in other ports of an aircraft's design; since the weight of Magnets 160 may be offset by reducing the weight of Flywheel 120 by a corresponding amount.

Coils 140 may be disposed near a front end of Engine 110. Coils 140 may have a plurality of windings, which may be made of copper, aluminum, or other conductive materials. The movement of Magnets 160 may generate electricity in Coils 140 via induction. Coils 140 may remain stationary while Magnets 160, rotated with Flywheel 120 by Output Shaft 170 provide a moving magnetic field. As this magnetic field passes through Coils 140, electricity may be generated. Alternatively, if electricity is sent through Coils 140 by an external source, such as a battery, a magnetic field may be produced. A magnetic field produced in Coils 140 may cause Magnets 160 to rotate due to like poles repelling, which may provide an electrical motor.

Lead Wires 150 may be electrically coupled to Coils 140, and may conduct any electricity generated to a control device for distributing or storing the electricity, such as a battery or an electrical bus. Coils 140 may be coupled electrically to a casing of Engine 110, which may allow one Lead Wire 150 to be sufficient to conduct electricity from Coils 140 to its destination.

A person skilled in the art will understand that Shaft-Driven Electrical Device may be made in various ways, and may utilize one or more different types of Magnets 160, one or more different types of Coils 140, and one or more different types of lead wires 150.

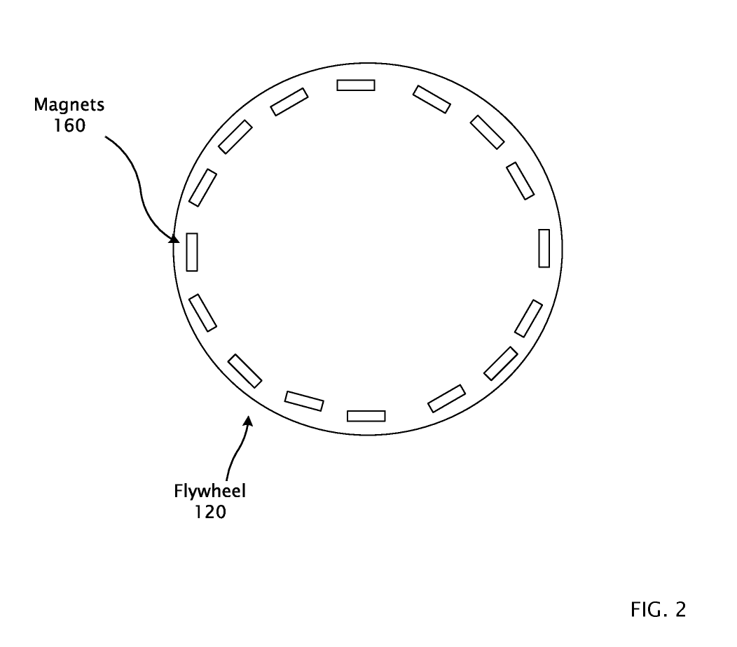

FIG. 2 is a view of Flywheel 120 with coupled Magnets 160, according to one embodiment. Magnets 160 may be disposed evenly spaced near the perimeter of Flywheel 120.

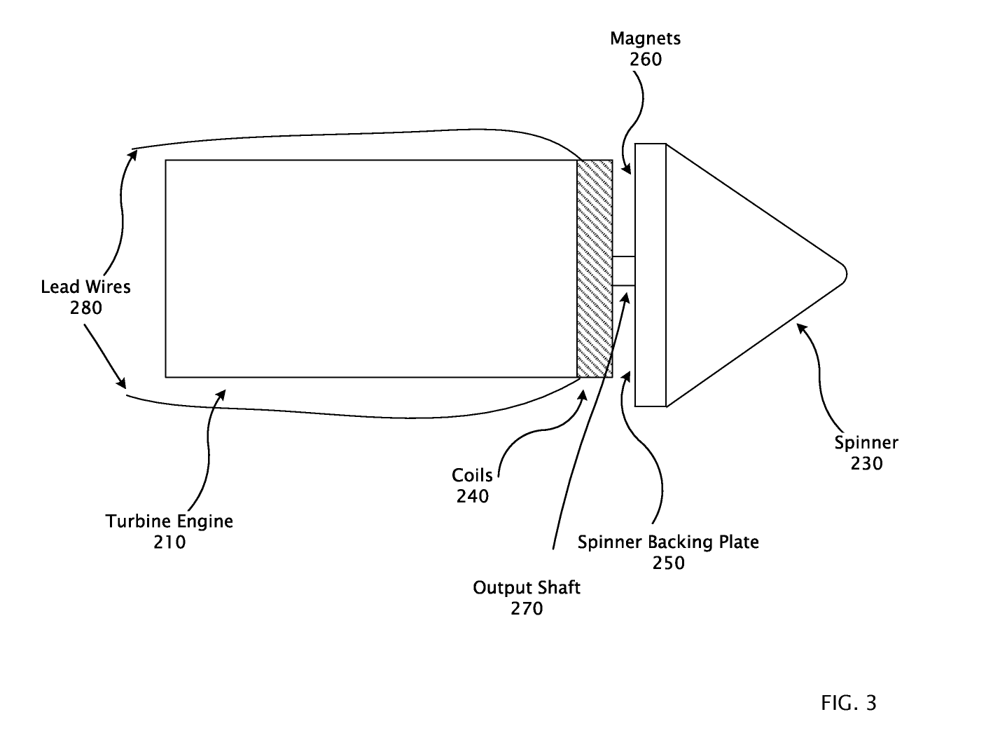

FIG. 3 is a side view of a shaft-driven electrical device, according to another embodiment. This embodiment may be used, for example, for Turbine Engine 110. Shaft-Driven Electrical Device 100 may be mounted to Turbine Engine 110. Spinner 230 may have Spinner Backing Plate 250, which may, for example, protect internal gearing for a propeller. Output Shaft 270 may be driven by Turbine Engine 210 in a conventional manner. Magnets 260 may be coupled to Spinner 250, which may be rotated by Output Shaft 270. Magnets 260 may be permanent magnets, or may be electromagnets. Many types of magnets may be used, and may be selected for cost, strength, weight, or other properties relevant to the application. Physical considerations, such as the distance between Spinner Backing Plate 250 and Coils 240 may be considered in selecting appropriate magnet types.

Coils 240 may be disposed near a front end of Turbine Engine 210. Coils 240 may have a plurality of windings, which may be made of copper, aluminum, or other conductive materials. The movement of Magnets 260 may generate electricity in Coils 240 via induction. Coils 240 may remain stationary while Magnets 260, rotated with Spinner Backing Plate 250 by Output Shaft 270 provide a moving magnetic field. As this magnetic field passes through Coils 240, electricity may be generated. Alternatively, if electricity is sent through Coils 240 by an external source, such as a battery, a magnetic field may be produced. A magnetic field produced in Coils 240 may cause Magnets 260 to rotate due to like poles repelling, which may provide an electrical motor.

Lead Wires 280 may be electrically coupled to Coils 240, and may be used to conduct any electricity generated to a device for distributing or storing the electricity. Coils 240 may be coupled electrically to a casing of Turbine Engine 210, which may allow one Lead Wire 280 to be sufficient to conduct electricity from Coils 240 to its destination.

A person skilled in the art will understand that any part of Shaft-Driven Electrical Device may be made in various ways, and may utilize one or more different types of Magnets 260, and one or more different types of lead wires 280.

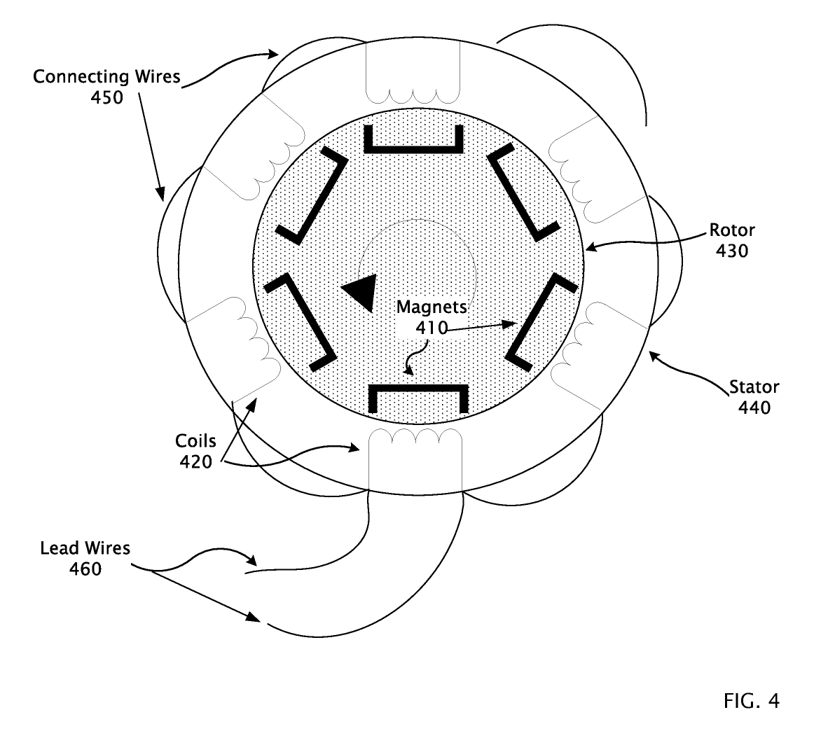

FIG. 4 is an illustration of a Shaft-Driven Electrical Device, according to one embodiment. In this embodiment, a plurality of Magnets 410 may be disposed on Rotor 430. Rotor 430 may be, for example, a flywheel or spinner coupled to an aircraft engine, or may be any device capable of handling rotational forces provided by an output shaft from the aircraft engine. A plurality of Coils 420 may be disposed on Stator 440, which may be coupled to a block of a piston aircraft engine or a case of a turboprop aircraft turbine engine, for example. Rotor 430 may rotate, driven by an output shaft of the aircraft engine. Magnets 410 may rotate near Coils 420, which may cause Coils 420 to experience a moving magnetic field and generate a current. Connecting Wires 450 may electrically couple Coils 420, which may permit generated electricity to be conducted to Lead Wires 460. Lead Wires 460 may conduct electricity to a device for distributing or storing the electricity, such as a battery or an aircraft's electrical bus.

Rotor 430 may spin inside Stator 440, or may be offset from Stator 440. One skilled in the art will recognize that various configurations are possible while allowing for generation of electricity.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A shaft-driven electrical device for an aircraft piston-engine, comprising:
an engine having a casing;
one or more lead wires, the lead wires configured to conduct electricity to an electrical control device or from the electrical control device;
a plurality of coils disposed on a first portion of the engine;
an output shaft extending from a first aperture of the casing and passing through a flywheel; and
a plurality of magnets disposed on a face of the flywheel facing the coils, providing moving magnetic fields which induce electrical current in the coils.

2. The shaft-driven electrical device according to claim 1, wherein the magnets are permanent magnets or an electromagnets.

3. The shaft-driven electrical device according to claim 1, wherein the coils are a plurality of windings.

4. The shaft-driven electrical device according to claim 1, wherein the coils are made of copper.

5. The shaft-driven electrical device according to claim 1, wherein the coils are made of aluminum.

6. The shaft-driven electrical device according to claim 1, wherein the shaft-driven electrical device serves as an electric generator, an electric motor, an electrical generator and an electrical motor or a starter.

7. A shaft-driven electrical device for a turbine engine, comprising:
an engine having a casing;
one or more lead wires, the lead wires configured to conduct electricity to an electrical control device or from the electrical control device;
a plurality of coils disposed on a first portion of the engine;
an output shaft extending from a first aperture of the casing and passing through a spinner backplate; and
a plurality of magnets disposed on a face of the spinner backplate facing the coils, providing moving magnetic fields which induce electrical current in the coils.

8. The shaft-driven electrical device according to claim 7, wherein the coils are a plurality of windings.

9. The shaft-driven electrical device according to claim 7, wherein the coils are made of copper.

10. The shaft-driven electrical device according to claim 7, wherein the coils are made of aluminum.

11. The shaft-driven electrical device according to claim 7, wherein the shaft-driven electrical device serves as an electric generator, an electric motor, an electrical generator and an electrical motor or a starter.
